(19) United States
(12) Patent Application Publication
(10) Pub. No.: US 2003/0009424 A1
(43) Pub. Date: Jan. 9, 2003

(54) Method for managing access and use of resources by verifying conditions and conditions for use therewith

(75) Inventors: Thanh Ta, Huntington Beach, CA (US); Thomas DeMartini, Culver City, CA (US); Joseph Z. Fung, Cerritos, CA (US); Guillermo Lao, Torrance, CA (US); Mai Nguyen, Buena Park, CA (US); Bijan Tadayon, Germantown, MD (US); Vincent Tieu, Torrance, CA (US); Duc Tran, Westminster, CA (US); Xin Wang, Torrance, CA (US); Edgardo Valenzuela, South Gate, CA (US)

Correspondence Address: NIXON PEABODY, LLP, 8180 GREENSBORO DRIVE, SUITE 800, MCLEAN, VA, 22102, US

(73) Assignee: CONTENTGUARD HOLDINGS, INC.

(21) Appl. No.: 10/163,634

(22) Filed: Jun. 7, 2002

Related U.S. Application Data
(63) Continuation-in-part of application No. 09/867,745, filed on May 31, 2001.
(60) Provisional application No. 60/331,623, filed on Nov. 20, 2001.
(60) Provisional application No. 60/331,624, filed on Nov. 20, 2001.
(60) Provisional application No. 60/331,625, filed on Nov. 20, 2001.
(60) Provisional application No. 60/331,621, filed on Nov. 20, 2001.
(60) Provisional application No. 60/296,113, filed on Jun. 7, 2001.
(60) Provisional application No. 60/296,117, filed on Jun. 7, 2001.
(60) Provisional application No. 60/296,118, filed on Jun. 7, 2001.

(51) Int. Cl. G06F 17/60

(52) U.S. Cl. 705/51

(57) ABSTRACT

A method and apparatus for managing access to resources that integrates both authorization and protection for a wide range of resources. The rights to access a protected resource are based on conditions. Conditions are associated with both resource the resource and the state of the resource to thereby protect the resource at various stages during its life cycle. Conditions that are associated with the entire life cycle of the protected resource can be expressed by use of a grammar including data structures, sets of rules or a language.

### RELATED APPLICATION DATA

This application claims benefit from U.S. provisional application Ser. Nos. 60/331,623 filed on Nov. 20, 2001, 60/331,624 filed on Nov. 20, 2001, 60/331,625 filed on Nov. 20, 2001, 60/331,621 filed on Nov. 20, 2001, 60/296,113, filed on Jun. 7, 2001, 60/296,117 filed on Jun. 7, 2001, and 60/296,118 filed on Jun. 7, 2001, the disclosures of which are incorporated herein by reference. This application is a continuation-in-part of copending application Ser. No. 09/867,745 filed on May 31, 2001, the disclosures of which is also incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

One of the most important issues impeding the widespread distribution of digital works (i.e. documents or other content in forms readable by computers), via electronic means, and the Internet in particular, is the current lack of ability to enforce the intellectual property rights of content owners during the distribution and use of digital works. Efforts to resolve this problem have been termed “Intellectual Property Rights Management” (“IPRM”), “Digital Property Rights Management” (“DPRM”), “Intellectual Property Management” (“IPM”), “Rights Management” (“RM”), and “Electronic Copyright Management” (“ECM”), collectively referred to as “Digital Rights Management (DRM)” herein. There are a number of issues to be considered in effecting a DRM System. For example, authentication, authorization, accounting, payment and financial clearing, rights specification, rights verification, rights enforcement, and document protection issues should be addressed. U.S. Pat. Nos. 5,530,235, 5,634,012, 5,715,403, 5,638,443, and 5,629,940, the disclosures of which are incorporate herein by reference, disclose DRM systems addressing these issues.

For example, U.S. Pat. No. 5,634,012, discloses a system for controlling the distribution of digital documents. Each rendering device has a repository associated therewith. A predetermined set of usage transaction steps define a protocol used by the repositories for enforcing usage rights associated with a document. Usage rights persist with the document content. The usage rights specify various manners of use of the content such as, viewing only, use once, distribution, and the like. Pre-conditions, such as payment of a fee, proof of identity or other conditions can be required prior to permitting access to the content in accordance with the usage rights. Once the pre-conditions are satisfied access to the content is granted. The concept of conditional access is well known in access control applications also. For example, it is known to grant access to network resources upon entry of login name and password.

The concept of conditional access is a foundation for both access control and DRM systems. A typical pre-condition, i.e. a condition for granting access, defines a list of authorized users along with a set of access rights and conditions to a given resource. Pre-conditions associated with a given resource can be defined as resources associated with certain users. This is known as “role-based” access control. Pre-conditions can also be defined by rules in a process known as “rule-based” access control. Both types of pre-conditions are expressed as an access control list, which is a set of resources or rules defined in some language or data structure.

Conditional access is typically implemented by most systems as an authorization process in which a principal (e.g., a person, a system or a process) is allowed access to a protected resource after certain conditions are met and/or verified.

### SUMMARY OF THE INVENTION

A first aspect of the invention is a method for managing use of protected resources within a system of resources. The method comprises granting access to a protected resource by a principal when pre-conditions associated with the protected resource and the principal are satisfied, permitting the principal to continue to access the protected resource while during-access conditions associated with the protected resource and the principal are satisfied, and terminating access to the protected resource by the principal when a termination event occurs. The termination event can be either the satisfaction of post conditions distinct from the during-access conditions or a failure to continue satisfaction of the during-access conditions.

A second aspect of the invention is a method for managing use of protected resources within a system of resources. The method comprises preparing pre-conditions that must be satisfied to obtain access to a protected resource, and preparing during-access conditions that must be satisfied to continue access to said protected resource. When said protected resource is inactive, enforcing said preconditions until said preconditions are satisfied; and rendering said protected resource active and enforcing said during-access conditions when said pre-conditions have been satisfied.

A third aspect of the invention is a condition specification adapted to associate a condition with a protected resource to control the protected resource within a system for managing protected resources. The specification comprises a resource designation indicating the protected resource that the condition is associated with, a state variable indicating a status of the resource with respect to the condition, a method specification indicating a manner by which the value of the state variable can be obtained form a device.

### BRIEF DESCRIPTION OF THE DRAWING

The invention is described through a preferred embodiment and the attached drawing in which:

FIG. 1 is a block diagram of a computer architecture of the preferred embodiment;

FIG. 2 is a schematic illustration of the states of a conventional access control model;

FIG. 3 is a schematic illustration of the states of the preferred embodiment;

FIG. 4 is a flow chart of the authorization process of the preferred embodiment;

FIG. 5 is a schematic illustration of a condition of the preferred embodiment; and

FIG. 6 is a schematic illustration of a condition state of the preferred embodiment;

### DETAILED DESCRIPTION

Different types of resources require different types of conditions and different mechanisms to protect them from unauthorized use. Applicant has extended the conventional pre-conditions to include conditions for both protection and commitment to thereby obtain a flexible mechanism to express and enforce such conditions.

In the preferred embodiment conditions are part of the entire lifecycle of protected resources. This means that conditions are not just evaluated prior to allowing access, but are also evaluated during the actual consumption of the resource. Additionally, conditions are associated with both the protected resource and the state of the protected resource. Associating conditions with various states of a protected resource provides content owners or service providers a flexible way to protect different types of resources. Resources can be digital content, hardware, software programs, memory space, goods, services (including web services), time, fees, usage rights or a license.

Usage rights, specify manners of use. For example, a manner of use can include the ability to use an item in a specified way for a specified period of time. Further, usage rights can specify transfer rights, such as distribution rights and can permit granting of usage rights to others or the derivation of usage rights.

The preferred embodiment verifies and validates conditions prior, during and after the usage or consumption of protected resources. Conditions can be represented as a condition state so that the current state and history of each condition can be logged and later used. “State variables” track potentially dynamic conditions. State variables are variables having values that represent status of a resource or other dynamic conditions. State variables can be tracked, and the value of state variables can be used in a condition. For example, a usage right, as a resource, can be the right to view content and a condition can be that no other users are logged into the network when the usage right is exercised. In this example, when the value of the appropriate state indicates that other users are logged in, the condition is no longer satisfied and the content can not be viewed, or viewing is terminated.

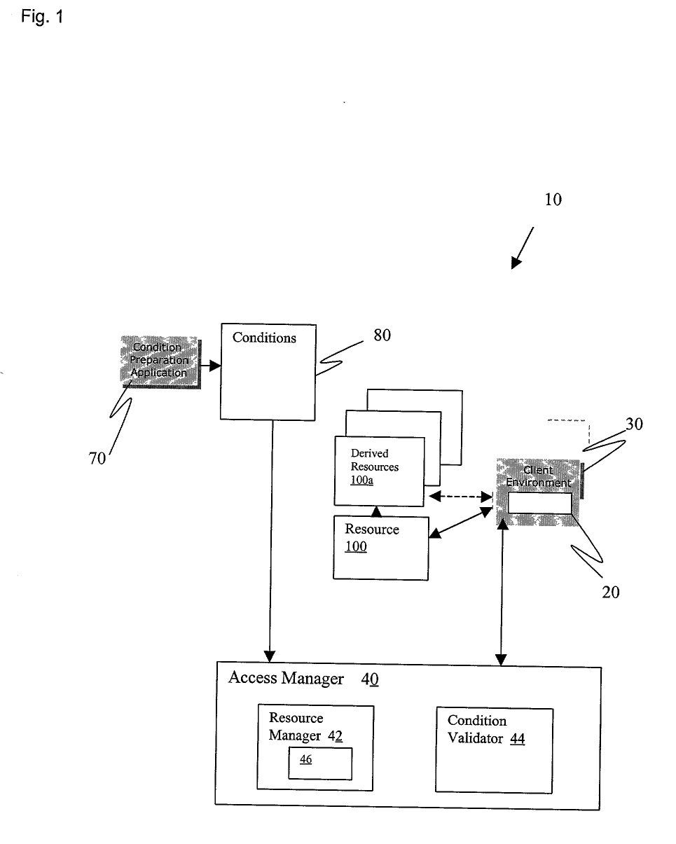

FIG. 1 illustrates computer architecture 10 of the preferred embodiment. Conditions 80 are described in detail below and can be prepared with preparation application 70 associated with the distributor of an item, a content service provider, an enterprise manager or any other party wishing to control access to resources, such as digital content. A grammar such as XrML™ can be used to specify conditions 80. However, conditions 80 can be specified in any manner. A user operates within client environment 30, including a computer or other device associated with the user. Software application 20, such as a rendering engine or other application, can be installed in client environment 30. Access manager 40 controls access to protected resource(s) 100 and derived resource(s) 100a in the manner set forth below.

Access manager 40, a computer device in the preferred embodiment, addresses security aspects of access to resource 100 and derived resource 100a. In particular, access manager 40 may authenticate messages by verifying and validating signatures, such as a cryptographic signature, or other identifying characteristics of the messages in a known manner. Access manager 40 includes two primary components, resource manager 42 and condition validator 44. Resource manager 42 is responsible for resource registration, resource transformation, and resource termination. “Transformation” refers to deriving derived resource 100a from resource 100. For example, in the case where the resource is an encrypted file which represents an image or the like, the derived resources 100a could include the clear image itself and the address of the memory that holds the image. During resource registration the memory address that holds the image is recorded by resource repository 46 of resource manager 42, so that any access to that memory, i.e. derived resource 100a, can be tracked. In addition, tracking marks (such as a watermark) can be inserted into the image, so that it can be tracked at any time.

Condition validator 44 monitors the set conditions and manages the current state of the system. Condition validator 44 interacts with the resource manager 46, as described in greater detail below, to control derived resource 100a. When the current system state is no longer valid, condition validator 44 requests resource manager 42 to delete (or disable) all the derived resources 100a or to notify application 20 that the use of derived resources 100a is no longer allowed as described in greater detail below.

Access to protected resource 100 is based on conditions 80. This type of condition is referred to as an access condition or “pre-condition.” However, by associating conditions with both resource 100 and the state of resource 100, it becomes possible to protect resource 100 at various stages during its life cycle. Resource 100 can be protected before a user is granted access, when access is granted, during the actual use of resource 100 and after the use of resource 100. Conditions 80 that are associated with the entire lifecycle of the protected resource can be expressed by use of a grammar including data structures, sets of rules or a language such as XrML™. The preferred embodiment uses of XrML™ as the language to express conditions.

To protect resource 100, conditions 80 can be imposed on resource 100 itself, or any other resources—either tangible or intangible—including those resources that make up any executing environments, such as a application 20 of client environment 30, from which protected resource 100 is accessed and used.

Conditions 80 can be the identity of a user or a group of users who is/are granted access as principals and who use protected resource 100. Examples of conditions 80 are set forth below as expressed in the XrML™ language. Example A expresses a condition associated with a principal “Edgar” who is granted the right to “view” the protected digital content “XrML Book”. Example B expresses a condition associated with a group of principals, i.e. all persons that fall under the category “ContentGuard employee” who are granted the right to print the protected digital work “XrML Book”.

Example A:
<license>

<inventory>

<digitalWork licensePartID=“XrMLBook”/>
<keyHolder licensePartID=“Edgar”/>

</inventory>
<grant>

<keyHolder licensePartIDRef=“Edgar”/>
<view/>
<digitalWork licensePartIDRef=“XrMLBook”/>

</grant>

</license>
Example B:
<license>

<inventory>

<digital Work licensePartID=“XrMLBook”/>

</inventory>
<grant>

<forAll varName=“ContentGuard Employee”/>
<principal varRef=“ ContentGuard Employee”/>
<print/>
<digitalWork licensePartIDRef=“XrMLBook”/>

</grant>

</license>

Conditions 80 can be conditions on principals who must possess certain properties, such as a certain title, or rights, such as a security clearance. Example C expresses the condition that principals must possess a manager's badge.

Example C:
<license>

<inventory>

<digitalWork licensePartID=“XrMLBook”/>
<keyHolder licensePartID=“Edgar”/>

</inventory>
<grant>

<forAll varName=“anyone”/>
<principal varRef=“anyone”/>
<possessProperty/>
<badge>
<title>Manager</title>
</badge>
<view/>
<digitalWork licensePartIDRef=“XrMLBook”/>

</grant>

</license>

Conditions 80 can be conditions on the time interval for access to the protected item. Example D below expresses conditions that key holder “Edgar”, as a principal, can view the content “XrML book” not before May 29, 2002 and not after May 29, 2003.

Example D:
<license>

<inventory>

<digitalWork licensePartID=“XrMLBook”/>
<keyHolder licensePartID=“Edgar”/>

</inventory>
<grant>

<keyHolder licensePartIDRef=“Edgar”/>
<view/>
<digitalWork licensePartIDRef=“XrMLBook”/>
<validityInterval>

<notBefore>2002-05-29T00:00:00</notBefore>
<notAfter>2003-05-29T00:00:00</notAfter>

</validityInterval>

</grant>

</license>

Conditions 80 can be related to the physical location of the principal or resource used to access content. Example E below expresses the condition that anyone currently in US can print the content “XrML Book”

Example E:
<license>

<inventory>

<digitalWork licensePartID=“XrMLBook”/>

</inventory>
<grant>

<forAll varName=“anyone”/>
<principal varRef=“anyone”/>
<print/>
<digitalWork licensePartId=“XrMLBook”/>
<territory>

<country>US</country>

</territory>

</grant>

</license>

Conditions 80 can specify a fee that the principal must pay for access. Example F below expresses the condition that anyone can print the content “XrML book” upon payment of a fee of $3.10. Example G below expresses the condition that anyone can print the content “XrML book” upon payment of a fee of $3.10 for each print. Example H below expresses the condition that anyone can view the content “XrML book upon payment of a fee of $10.00 per hour of viewing time.

Example F:
<license>

<inventory>

<digitalWork licensePartID=“XrMLBook”/>

</inventory>
<grant>

<forAll varName=“anyone”/>
<principal varRef=“anyone”/>
<print/>
<digitalWork licensePartId=“XrMLBook”/>
<fee>

<paymentFlat>
<rate currency=“USD”>3.10</rate>
</paymmentFlat>
<to>
<aba>
<institution>123456789></institution>
<account>987654321</account>
</aba>
</to>

</fee>

</grant>

</license>
Example G:
<license>

<inventory>

<digitalWork licensePartID=“XrMLBook”/>

</inventory>
<grant>

<forAll varName=“anyone”/>
<principal varRef=“anyone”/>
<print/>
<digitalWork licensePartIDRef=“XrMLBook”/>
<fee>

<paymentPerUse>
<rate currency=“USD”>3.10</rate>
</paymentPerUse>

</fee>

</grant>

</license>
Example H:
<license>

<inventory>

<digitalWork licensePartID=“XrMLBook”/>
</inventory>

<grant>
<forAll varName=“anyone”/>
<principal varRef=“anyone”/>
<view/>
<digitalWork licensePartIDRef=“XrMLBook”/>

<fee>

<paymentMetered>
<rate currency=“USD”>10.00</rate>
<per>PT1H</per>
<phase>PT10M</phase>
</paymementMetered>
<to>
<aba>
<institution>123456789></institution>
<account>987654321</account>
</aba>
</to>

</fee>

</grant>

</license>

Example I below expresses the condition that anyone can print the content but the exercise of the print right will be tracked by a tracking service before printing.

Example I:
<license>

<inventory>

<digitalWork licensePartID=“XrMLBook”/>
<keyHolder licensePartID=“Edgar”/>

</inventory>
<grant>

<forAll varName=“anyone”/>
<principal varRef=“anyone”/>
<print/>
<digitalWork licensePartIDRef=“XrMLBook”/>
<trackReport>

<stateReference>

<uddi>
<serviceKey>
<uuid>...</uuid>
</serviceKey>
</uddi>
<serviceParam>
</serviceParam>

</stateReference>

</trackReport>

</grant>

</license>

Conditions 80 may also be conditions on the system in which resource 100 is consumed. For example, condition 80 may require that the system has an authorized security mechanism or other specific hardware or software, or only a specific maximum number of users are logged on.

Conditions 80 can specify the repository or other device in which resource 100, such as content, resides. Conditions 80 can relate to the approval notice that the principal must obtain before using the protected resources 100. Conditions 80 can require notification before or after using resource 100. Conditions 80 can specify the previous rights related to the protected resource 100 or other resources. Conditions 80 can also be imposed on other conditions 80 such as how to verify a condition.

Of course, conditions 80 are not limited to the above examples, but can be any restriction, obligation or requirement that is associated with protected resource 100 as pre-conditions, during-access conditions and post-conditions. Also, even though the examples above are expressed using XrML™ conditions are not limited to or by XrML and can be expressed in any manner.

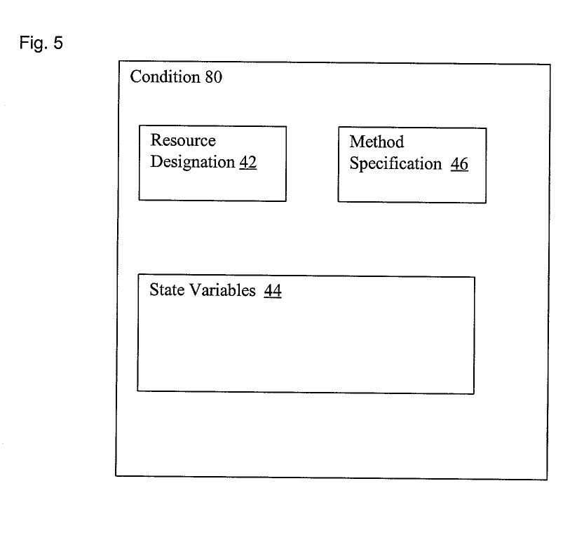

FIG. 5 schematically illustrates condition 80 in accordance with the preferred embodiment. Condition 80 includes resource designation 42 which can be expressed either implicitly or explicitly. For example, in Example A above, resource designation 42 is indicated by the attribute “licensePartID” of the “digitalWork” elements. Condition 80 also includes state variables 44, and method specification 46 indicating how values of state variables 44 can be obtained. Method specification 46 can include the location(s) where values of state variables 44 are stored (such as a remote server that manages a condition), the communication protocol to communicate with the server where the condition is managed, and any parameters needed to obtain the value (such as service parameters, etc). Alternatively, the method can be hard-coded in the system and method specification 46 can be omitted.

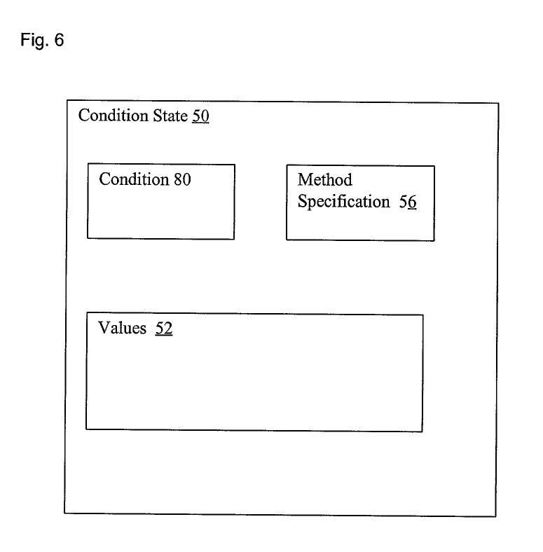

As noted above, state variables 44 represent the status of condition 80. The collection of all state variables 44 for a given right is referred to herein and a “state of rights”. Each state variable 44 has a corresponding value at any moment in time for the principal, right, and resource. The collection of all state variables 44 of a condition 80 is referred to simply as a “condition state” herein. FIG. 6 illustrates condition state 50 which includes condition 80, and current values 52 for state variables 44 of condition 80. Method specification 56 indicates the method used to obtain current values 52 of state variables 44, including potentially a source from which the value is obtained, the digital signature of a credential, the session ID of the request and any other appropriate information. Note that method specification 56 can be considered redundant with method specification 46 and can merely be a reiteration thereof. However, in some cases, method specification 56, used to actually obtain values 52, can be different than method specification 46, which is suggested for use in condition 80.

Using condition state 50 to represent condition 80 for a right simplifies the process of verifying conditions 80 because all the information needed to verify condition 80 is readily accessible. Condition state 50 is constructed and then used whenever the corresponding condition 80 is evaluated and verified. Each condition state 50 can contain all information needed to verify values 52 of state variables 44. A collection of condition states 50 for a given right associated with an authenticated principal and protected resource 100 is referred to as a “system state” herein.

An authenticated principal is a user that has been processed by a system which validates the authenticity of that user, for example when a user successfully logs-in with a user name and a password, the user becomes an authenticated principal or just “principal”. Using the “system state” concept, condition 80 for a given set of rights is defined as a set of required system states under which a principal is allowed to access to protected resource 100. When an authenticated principal wishes to access protected resource 100, the system state changes from an “original state” to an “authorized state”.

Once the system is in an authorized state the principal is then able to access the protected resource 100 for an authorized operation. In many cases, it is not the authenticated principal itself that actually accesses protected resource 100. For example, the access can be delegated to another authenticated principal such as a rendering application, service, or the like. While protected resource 100 is being accessed and consumed, the set of pre-access conditions 80 for granting the initial access may no longer be applicable for authorizing continued access. Also, consuming protected resource 100 may transform the resource into a set of temporary, .i.e., derived, resources 100a from which the access conditions 80 imposed on the original resources are also not applicable. In order to protect resource 100 and its derived resources 100a while they are being accessed, the preferred embodiment uses a concept for authorization and protection called “during-access conditions” which is described in detail below.

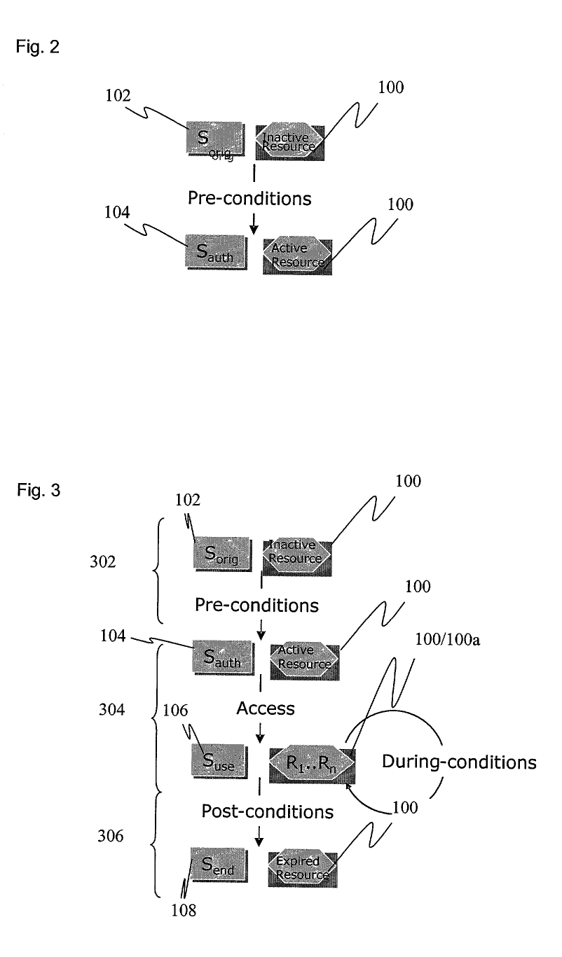

In a conventional system, resources are in one of two states. As illustrated in FIG. 2, when resource 100 is inactive, the system is in original state 102 until pre-conditions are satisfied. At that time, resource 100 becomes active and the system enters the authorized or active state 104. To increase control over resources, the preferred embodiment defines two additional states in addition to the “original state” and “authorized state”. As illustrated in FIG. 3, during the use or access of protected resource 100, the system state will change through the following states: original state 102, authorized state 104, usage state 106 and end state 108. Conditions 80 can be defined, for each state, that must be met in order to move to the next state or continue within the same state. As note above with respect to FIG. 1, conditions 80 can be defined and prepared using preparation application 70 including any necessary user interface and editing capabilities. Conditions 80 that need to be satisfied to enter the Authorized State are called “pre-conditions”. Conditions 80 that need to be satisfied during the use of resource 100 are called “during-access conditions” and conditions 80 that are required at the end of the use are called “post-conditions”. Condition validator 44 can invoke the requisite conditions 80 for each state.

During-access conditions are conditions 80 that are transferred from the original resource 100 to itself and any of derived resources 100a while they are being accessed and consumed by an authenticated principal. For example, if resource 100 is a document which is displayed on a screen of client environment 30 during the authorized operation “view,” then derived resources 100a may include the memory that contains the data from the document, the presentation format of the document, and the displayed windows respectively. Derived resources 100a will all be protected by the set of during-access conditions. In other words, the principal will only have access to derived resources 100a as long as the during-access conditions are satisfied. During-access conditions can be defined in the same manner as other conditions 80.

Another example is where an application, such as a application 20, or other user requests a service that is a protected resource 100. Once the request is authorized, the application that executes the service may be considered as a derived resource and is subjected to the set of during-access conditions while the service is being executed. During-access conditions continuously change the system state until the derived resources are no longer used or the system state becomes unauthorized. Once the requested operation is completed, either mandatory or voluntarily, all derived resources 100a protected by during-access conditions are deleted (or disabled) and the system state is then transferred to the final state by the set of post-access conditions.

Conditions 80 after or during the use or access of a resource may or may not change. Those conditions with unchanged state are called “stateless conditions”, while conditions that change after or during the use of the resource are called “stateful conditions”. Pre-conditions 80 are usually stateless conditions 80 and are used to control the access to the protected document. During-access conditions and post-conditions are usually stateful conditions 80. They are used to control the lifetime of protected resource 100. (For example, protected resource 100 can no longer be accessed once a specific number of users logged into a network has been exceeded.) With these expanded types of conditions 80 associated with different stages of protected resource 100, the preferred embodiment provides a mechanism to authorize the use of protected resource 100 and to protect and track resource 100 while it is being used.

As illustrated in FIG. 3 and with reference to elements of FIG. 1, a system in accordance with the preferred embodiment progresses through three stages. Access Authorization stage 302 is a stage in which access manager 40 authorizes an authenticated principal to access protected resource 100 for an authorized operation through verifying that pre-conditions are satisfied. Resource protection stage 304 is a stage in which access manager 40 protects resource 100 and its derived resources 100a while they are being used by verifying that the during-access conditions remained satisfied. Operation termination stage 306 is a stage in which access manager 40 terminates the use of protected resource 100 and derived resources 100a for a given operation when post-access conditions are satisfied or during-access conditions otherwise cease being satisfied.

In recursive situations, in which multiple accesses are given for the same resource 100, the post-condition can be the same as the pre-condition of the next cycle. In such a case, a non-static parameter can be used in order to prevent infinite loop situations. For example a time-dependent condition or a condition modified or imposed by an external entity, such as human intervention.

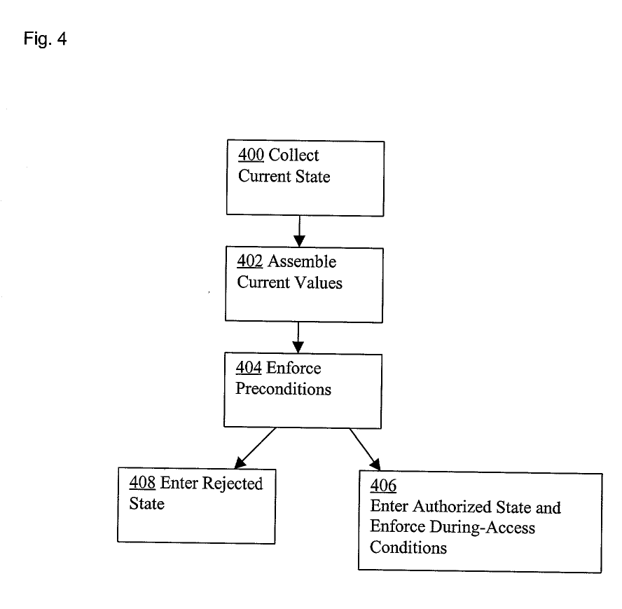

Access authorization grants an authenticated principal the right(s) to access protected resource 100 for an authorized operation. FIG. 4 illustrates an access authorization procedure in accordance with the preferred embodiment which includes collecting the current system state based on the list of conditions 80 associated with the authenticated principal, operation, and protected resource 100 in step 400. Each state condition 50 can be obtained either from the local system or remote system, from a device, an application, a repository or a service by access manager 40. The result of step 400 is the original state. In step 402, current values 52 of each state variable 44 in the pre-conditions are collected by access manager 40. Current values 52 can be assembled into a record, an XML document for example. Information used to construct the record can be authenticated (for example, authentication of the principal or the resource 100). In step 404, the pre-conditions are evaluated, i.e., enforced, against the record. For example, the information stored in the record, which contains current value 52 for each state variable 44 of the pre-conditions, can be accepted and/or subjected to various processing, such as verifying a signature of the record or reevaluating all pre-condition values. If enforcement is successful, resource 100 and any derived resources 100a enter the authorized state in step 406.

Depending on the method used by condition validator 42 in validating the set of pre-access conditions, the authorization process can be classified as “voluntary” or “mandatory”. A process that accepts the values of the state variables 44 stored in the record discussed above is called a “voluntary” process and a system that challenges those values is called a “mandatory” process. In a mandatory process protected resource 100 and all its derived resources 100a are disabled as soon as any condition 80, including pre-conditions, during-access conditions or post-conditions, cannot be satisfied. When resources 100 or derived resources 100a are disabled (or become invalid) application 20 is no longer able to access protected resource 100. In a voluntary process, application 20 is notified if any condition 80 cannot be satisfied and becomes invalid. Application 20 is then responsible for disabling protected resource 100 and derived resources 100a. The decision on whether to disable could be done automatically or with human intervention. Enforcement step 404 will change the system from its original state to either an authorized state (step 406) or a rejected state (step 404). In an authorized state, protected resource 100 is released to either the requested principal or its delegated principal and during conditions begin to be enforced. Note that during access conditions can be distinct from pre-conditions to provide flexible control of resources 100.

As noted above, resource protection protects both the initial protected resource 100 and its derived resources, 100a by enforcing the set of during-access conditions. The authorized state returned from the access authorization state contains the list of during-access conditions to be enforced during the authorized operation. In a mandatory system all derived resources 100a can be registered with resource repository 46 of resource manager 42 when derived resources 100a are generated and used. If any during-access condition becomes invalid resource manager 42 will disable access to protected resource 100 and derived resources 100a by application 20.

In other types of systems, for example a “tracking system”, a tracking object, such as special mark or ID, is inserted into derived resource 100a during the resource registration and transformation. This enables tracking of the resources by the resource protection component. The insertion mark can be in a format transparent to the application that processes the derived resource 100a. Tracking systems can be either mandatory or voluntary systems.

The termination of an authorized operation executes the set of post conditions (if any are present). Executing post-conditions permanently change the system state and affects the next request for access to resource 100. For example, if a post condition is the removal of access to the resource 100 after an exercise limit has been reached, when the limit is reached the resource 100 is deleted or some other action is taken which disables or prevents access. Operation termination can include resource termination. Resource manager 42 can delete (disable) derived resources 100a when the operation is being terminated, whether or not the operation is forced to terminate, or the application is voluntarily terminating the operation. Deletion (or disabling) of derived resource 100a is important in the process of protection of resource 100. Condition validator 44 commits the use of protected resource 100 and enforce the set of post-conditions. Condition validator 44 will invalidate (disable) protected resource 100 if resource 100 becomes invalid as a result of the change in the system state.

The preferred embodiment can utilize various devices, such as a personal computers, servers, workstations, PDA's, thin clients and the like. For example, the client environment can be a handheld device such as a mobile phone or a PDA. Various channels for communication can be used. Further, the various functions can be integrated in one device. The disclosed functional devices and modules are segregated by function for clarity. However, the various functions can be combined or segregated as hardware and/or software modules and devices in any manner. The various functions modules and devices have utility separately or in combination.

The various records, messages, elements and portions thereof can be stored on the same device or on different devices. Various links, references, specifications, and the like can be used to associate the elements. Access to any type of resource can be controlled. Any mechanism for tracking values of state variables can be used.

The invention has been described through a preferred embodiment and examples. However, various modifications can be made without departing from the scope of the invention as define by the appended claims and legal equivalents.

What is claimed:

1. A method for managing use of protected resources within a system of resources, said method comprising:
granting access to a protected resource by a principal when pre-conditions associated with the protected resource and the principal are satisfied;
permitting the principal to continue to access the protected resource while during-access conditions associated with the protected resource and the principal are satisfied, said during-access conditions being distinct from said preconditions; and
terminating access to the protected resource by the principal when a termination event occurs, said termination event comprising either the satisfaction of post conditions distinct from said during-access conditions or a failure to continue satisfaction of said during-access conditions.

2. A method as recited in claim 1, wherein said pre-conditions are associated with a usage right and wherein said protected resource comprises a primary resource associated with the usage right and derived resources for exercising the usage right in connection with the primary resource.

3. A method as recited in claim 2, wherein said primary resource is digital content and said derived resources are resources for rendering said protected content.

4. A method as recited in claim 1, where said during-access conditions specify state variables indicating a state of the protected resource and wherein values of said state variables are evaluated against said during-access conditions to determine if said during-access conditions are satisfied.

5. A method as recited in claim 2 wherein said during-access conditions are applied to said primary resource and said derived resources.

6. A method as recited in claim 1, wherein said during-access conditions include conditions on the state of the system in which the protected resource is accessed.

7. A method as recited in claim 1, wherein said during-access conditions include conditions on the device in which the protected resource resides.

8. A method as recited in claim 1, wherein said protected resource is digital content.

9. A method for managing use of protected resources within a system of resources, said method comprising;
preparing pre-conditions that must be satisfied to obtain access to a protected resource;
preparing during-access conditions that must be satisfied to continue access to said protected resource;
when said protected resource is inactive, enforcing said preconditions until said preconditions are satisfied; and
rendering said protected resource active and enforcing said during-access conditions when said pre-conditions have been satisfied.

10. A method as recited in claim 9, further comprising the step of terminating access to the protected resource by the principal when a termination event occurs, said termination event comprising either the satisfaction of post conditions distinct from said during-access conditions or a failure to continue satisfaction of said during-access conditions.

11. A method as recited in claim 10, wherein said pre-conditions are associated with a usage right and wherein said protected resource comprises a primary resource associated with the usage right and derived resources for exercising the usage right in connection with the primary resource.

12. A method as recited in claim 11, wherein said primary resource is digital content and said derived resources are resources for rendering said protected content.

13. A method as recited in claim 10, where said during-conditions specify state variables indicating a state of the protected resource and wherein values of said state variables are evaluated against said during-conditions to determine if said during-conditions are satisfied.

14. A method as recited in claim 11 wherein said during-access conditions are applied to said primary resource and said derived resources.

15. A method as recited in claim 10, wherein said during-access conditions include conditions on the state of the system in which the protected resource is accessed.

16. A method as recited in claim 10, wherein said during-access conditions include conditions on the device in which the protected resource resides.

17. A method as recited in claim 8, wherein said protected resource is digital content.

18. A condition specification adapted to associate a condition with a protected resource to control the protected resource within a system for managing protected resources, said specification comprising:
a resource designation indicating the protected resource that the condition is associated with;
a state variable indicating a status of the resource with respect to the condition; and
a method specification indicating a manner by which the value of the state variable can be obtained form a device.

19. A condition specification as recited in claim 18, wherein said method specification includes a location of a device on which the value of the state variable is stored.

20. A condition specification as recited in claim 18, wherein said method specification includes a communication protocol for obtaining the value of the state variable.

21. A condition specification as recited in claim 18, further comprising a usage right to be exercised when the condition is satisfied.

22. A condition specification as recited in claim 18, wherein the condition is a during-access condition that must be satisfied to continue use of a resource after access to the resource has been granted.
